(19) United States
(12) Patent Application Publication
(10) Pub. No.: US 2003/0048087 A1
(43) Pub. Date: Mar. 13, 2003

(54) Method for protecting an electrical motor against thermal overload

(76) Inventor: Wolfgang Schulter, Meersburg (DE)

Correspondence Address: FASSE PATENT ATTORNEYS, P.A., P.O. BOX 726, HAMPDEN, ME, 04444-0726, US

(21) Appl. No.: 10/181,742

(22) PCT Filed: Jan. 10, 2001
(86) PCT No.: PCT/EP01/00231

(51) Int. Cl. H02P 1/04

(52) U.S. Cl. 318/471

(57) ABSTRACT

There is suggested a simple, cost-effective and secure method for the protection of an electrical motor against thermal overload. For this purpose, a motor equation combining at least one temperature dependent motor parameter and at least one motor characteristic quantity is defined in connection with a motor model for the electrical motor. The presently existing values of the at least one motor characteristic quantity are determined in at least two successive measuring times of a measuring process. The value of the at least one temperature dependent motor parameter is determined in connection with the motor equations for the measuring times of a measuring process. The absolute value of the temperature of the electrical motor is determined in connection with motor equations derived in the measuring times of a measuring process while taking into account the functional relationship between the at least one temperature dependent motor parameter and the temperature. If the determined absolute value of the temperature of the electrical motor reaches a prescribed limit temperature, defined measures are taken for the current flow through the electrical motor. Method for the protection of an electrical motor in an electrical drive unit for window lift drives.

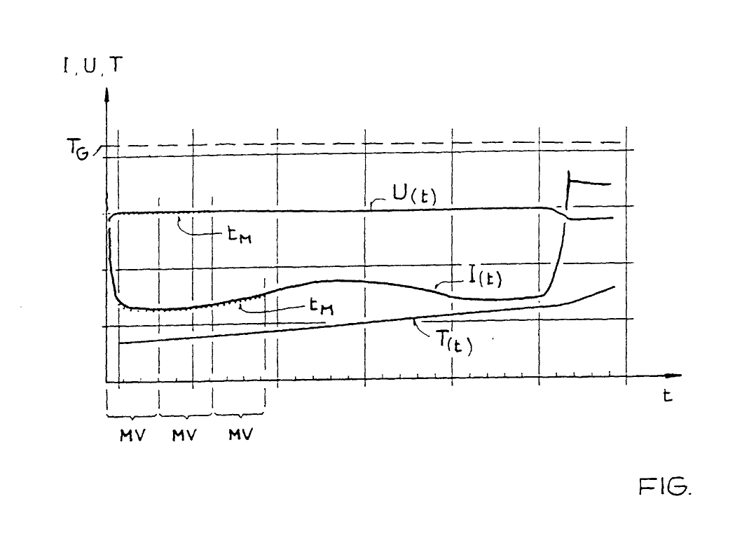

Electrical drive units are used in many diverse fields of application for operating movable parts; for example, in the motor vehicle field, various movable parts of the motor vehicle (seats, window lifters, sliding sunroofs, etc.) are adjusted by means of electrical drive units. Electrical drive units consist of an electrical motor (for example a direct current motor) for generating and providing electrical drive power and of an electronic module for controlling and monitoring the electrical motor (for example for the rotational speed and power regulation of the electrical motor), and also, if applicable, for realizing additional functions.

Since the electrical motors of these electrical drive units are generally not capable of continuous load operation for cost reasons and due to weight saving, they must be protected against a thermal overload (before an overheating due to self-heating) which often leads to destruction. In this context, critical elements of the electrical motor are the armature winding, the carbon brushes, the bearings, as well as all plastic parts. For the protection of the electrical motor against thermal over-load, a thermal switch (for example a bimetallic switch) can be provided in the interior of the electrical motor, whereby upon reaching a certain limit temperature, the thermal switch trips or actuates and interrupts the current flow through the electrical motor (the motor current). Disadvantageous in this context are the costs and the space requirement of the thermal switch in the electrical motor, and the deactivation of all functions of the electrical drive unit upon the tripping or actuating of the thermal switch, especially also the emergency functions (for example, in electrical drive units with a pinch protection, an interruption of the motor current by the thermal switch can take place exactly when an obstacle has become pinched—thus the electrical motor can no longer be moved, for example, thus also the rotation direction of the electrical motor can no longer be reversed).

From the EP 0 332 568 B1 and the DE 25 49 850 A1, methods are known which determine a temperature increase during the operation of the electrical motor, indirectly from the heat generated due to the electrical power of the motor that is given off. Hereby it is disadvantageous that only relative temperatures are considered and the absolute temperature (the actual temperature) is not known; therefore, for safety reasons, the highest arising ambient surrounding temperature must be considered (“worst case” consideration) for the definition of limit temperatures, whereby the field of application of the electrical motor is sharply limited.

The underlying object of the invention is to present a method for the protection of an electrical motor against thermal overload, which comprises comparative advantageous characteristics, especially with which a protection of the electrical motor can be achieved, without limitation of the field of application, in a simple manner and with low costs, and with a nonetheless high reliability.

This object is solved according to the invention by the features in the characterizing portion of the patent claim 1. Advantageous further embodiments of the method are the subject of the further patent claims.

Underlying the invention is the recognition that a very efficient protection of the electrical motor against thermal overload can be implemented, if, with knowledge of motor characteristic quantities of the electrical motor (for example motor current, motor voltage and motor rotational speed or period duration) while taking into account at least one temperature dependent motor parameter, absolute temperatures are determined as a decision criterium for taking measures with respect to the current flow through the electrical motor.

On the basis of a prescribed functional relationship between the at least one temperature dependent motor parameter and the temperature (that is to say the prescribed functional temperature dependence of the at least one motor parameter) and with knowledge of a reference value for the at least one temperature dependent motor parameter (for example either based on a reference measurement at a defined temperature or based on a prescribed standard value at a defined temperature), one obtains a relationship for the absolute temperature, in which the value (absolute value) of the at least one temperature dependent motor parameter is still undetermined. A motor equation is defined, in connection with a motor model for the electrical motor, which combines the at least one temperature dependent motor parameter and at least one motor characteristic quantity; hereby there is established a relationship between the considered motor characteristic quantities on the one hand (for example motor current or armature current and/or motor voltage and/or motor rotational speed or period duration of the motor rotation), and the at least one temperature dependent motor parameter on the other hand. During an operating process of the electrical motor, at least one measuring process is prescribed: during each measuring process, the present existing values of the considered motor characteristic quantities are determined in at least two successive measuring times, and with the aid of the motor equations for the measuring times that result therefrom, the values (absolute values) of the at least one temperature dependent motor parameter are determined; for example the values of the at least one temperature dependent motor parameter are determined in connection with the motor equations obtained in the measuring times of a measuring process (that is to say in connection with an equation system with a number of equations corresponding to the number of the measuring times of a measuring process) by means of matrix transformation (Gauss transformation) while using transposed matrices, or for real-time applications with microcontrollers while using adaptive algorithms that converge toward the “correct” solution, for example an LMS algorithm or an RLS algorithm. Now, with knowledge of the values of the at least one temperature dependent motor parameter, the absolute value of the temperature of the electrical motor can be determined; then a limit temperature is defined for this absolute value of the temperature, and the reaching of this limit temperature serves as the decision criterium for the pre-setting or feeding of the current flow through the electrical motor (the armature current), for example as the switch-off criterium for switching off the current flow through the electrical motor.

Preferably, the electrical resistance of the armature winding of the electrical motor (the armature resistance) and/or the magnetic flux necessary for excitation of the electric motor are called upon as the temperature dependent motor parameters, and their values (absolute values) are determined from a motor equation that combines the motor characteristic quantities motor current (armature current), motor voltage and motor rotational speed as well as the called-upon temperature-dependent motor parameters armature resistance and magnetic flux with one another. Especially, from the temperature dependence of the magnetic flux, a conclusion can be reached as to the “outside temperature” of the electrical motor, that is to say one hereby obtains the temperature in the immediate surrounding vicinity of the electrical motor, while from the temperature dependence of the armature resistance, a conclusion can be reached as to the “inside temperature” of the electrical motor, that is to say one hereby obtains the temperature prevailing in the interior of the electrical motor itself (on the rotor of the electrical motor). The limit temperature, upon reaching of which the current flow through the electrical motor will be influenced (for example switched off), can be prescribed in a varying manner dependent on the called-upon temperature-dependent motor parameters—especially, different limit temperatures can also be prescribed for the “outside temperature” and the “inside temperature” of the electrical motor.

The values of the motor characteristic quantities determined during an operating process of the electric motor can also be taken into consideration for subsequent measuring processes and/or operating processes of the electrical motor, that is to say, in addition to the motor characteristic quantities measured during the subsequent measuring processes and/or operating processes, also the values of previous measuring processes and/or operating processes are considered—in this manner an average value formation is carried out and the influence of interferences is eliminated or reduced. The values of the temperature dependent motor parameters do not need to be determined during the entire operating process of the electrical motor in all cases; rather, it is often adequate to determine the value of a temperature dependent motor parameter during a measuring process in the start-up phase of the operating process of the electrical motor, and to use this value also for later measuring processes of this operating process of the electrical motor. This can be adequate especially for such temperature dependent motor parameters that are not sensitive with respect to various different operating conditions of the electrical motor or with respect to external influences (that is to say for temperature dependent motor parameters that are approximately constant for certain operating conditions of the electrical motor or for all operating conditions of the electrical motor).

The number of the measuring processes during an operating process of the electrical motor and the number of the measuring times per measuring process are especially prescribed dependent on the desired accuracy for the determination of the absolute temperature and of the operating conditions during the operating process; for example, for a high accuracy of the determination of the values of the temperature dependent motor parameters and therewith for a high accuracy of the determination of the absolute temperature during a measuring process, the present existing values of the motor characteristic quantities required for the motor equation are determined in a plurality of successive measuring times, so that one obtains, as a result thereof, a plurality of motor equations for the measuring process. In the event that a motor model that takes several motor characteristic quantities into account is defined, and herefrom a motor equation taking into account several motor characteristic quantities is derived, often not all of the motor characteristic quantities in the measuring times of a measuring process need to be measured for the determination of the present existing values of the motor characteristic quantities that are taken into account; but rather one or several motor characteristic quantities can be derived from the measured motor characteristic quantities with knowledge of the other motor characteristic quantities. For example, if a motor model is defined that takes into account the motor characteristic quantities motor current, motor voltage and motor rotational speed, and from this there is derived, a motor equation that takes into account the motor characteristic quantities motor current, motor voltage and motor rotational speed, then in the measuring times of a measuring process, the motor current and the motor voltage can be measured and from this the motor rotational speed can be derived, or the motor rotational speed and the motor voltage can be measured and from this the motor current can be derived.

Since the absolute temperature (the actual temperature) is called upon or used for setting the limit temperature and therewith as a decision criterium for the pre-setting or feeding of the current flow through the electrical motor, the electrical motor can be protected against thermal overload with high accuracy and a high reliability without limitation of the operating conditions; since the determination of the absolute temperature is carried out under consideration of the already known motor characteristic quantities, the method can be realized without additional effort, especially without space requirement or costs for additional sensors.

In relationship with the drawings, the method shall be explained in detail in connection with an example embodiment. Hereby the FIGURE shows the time course or progression of the motor characteristic quantities and of the temperature during an operating process of the electrical motor.

An electrical drive unit with a permanently excited direct current motor as an electrical motor is, for example, integrated in the door control device of a motor vehicle for realization of the electrical window lift function of the motor vehicle (as the window lift drive of a motor vehicle).

This permanently excited direct current motor as an electrical motor possesses a nominal power of, for example, 100 W and a maximum permissible operating temperature (limit temperature for the winding of the armature) of, for example, 150° C. Furthermore, sensors for detecting the motor voltage U and the armature current I of the electrical motor are provided; for this purpose, for example, sensors that are already provided in the electrical motor for other purposes can be utilized: for example, an evaluating unit is integrated into the electrical motor, whereby the evaluating unit, for example, comprises a voltage divider with an A/D converter connected in series thereafter for detecting the motor voltage, and a measuring resister (Shunt) with an amplifier and an A/D converter connected in series thereafter for detecting the armature current I.

For determining the absolute temperature T of the electrical motor, the armature resistance R(T) and the magnetic flux Φ (T) are called upon as temperature dependent motor parameters:

The temperature dependence of the armature resistance R(T) arises due to the production of the winding(s) of the electrical motor from a material with the temperature coefficient α:

R(T)=R_{REF}·[1+α(T−T_{REF})] (1)

From this equation (1), the absolute temperature T can be determined, when the temperature coefficient α, the reference temperature T_{REF}, the reference resistance R_{REF} and the resistance R are known. The temperature coefficient α is defined for a certain reference temperature T_{REF} (for example T_{REF}=20° C.) (for example for copper, α=+0.0038K⁻¹ results), the reference resistance R_{REF} is determined, for example, at the reference temperature T_{REF}=20° C. by a reference measurement; thus the absolute value of the armature resistance R remains as an unknown value for the determination of the absolute temperature T of the electrical motor.

The temperature dependence of the magnetic flux Φ(T) that is necessary for the excitation of the electrical motor (that is effective in the electrical motor) results, in the context of an excitation by permanent magnets, due to the temperature dependence of the permeability of the magnetic material with the temperature coefficient β. Thus for the temperature dependence of the magnetic flux Φ(T), there pertains an equivalent relationship as according to equation (1) for the armature resistance R(T):

Φ(T)=Φ_{REF}·[1+β(T−T_{REF})] (2)

From this equation (2), the absolute temperature T can be determined, when the temperature coefficient β, the reference temperature T_{REF}, the reference value Φ_{REF} for the magnetic flux Φ, and the magnetic flux Φ are known. The temperature coefficient β is defined for a certain reference temperature T_{REF} (for example T_{REF}=20° C.) (for example for barium hard ferrite, β=−0.002K⁻¹ results), the reference value for the magnetic flux Φ_{REF} is determined, for example, at the reference temperature T_{REF}=20° C. by a reference measurement; thus the absolute value of the magnetic flux Φ remains as an unknown value for the determination of the absolute temperature T of the electrical motor.

For determining the absolute values of the armature resistance R and the magnetic flux Φ, a motor model that combines the motor characteristic quantities motor current I (armature current), motor voltage U and motor rotational speed n as well as the temperature dependent motor parameters armature resistance R(T) and magnetic flux Φ(T) is defined, and from this a motor equation that takes into account the motor characteristic quantities armature current I, motor voltage U and motor rotational speed n is derived:

cΦ(T)·n=U−I·R(T)−(dI/dt)·L (3)

with c=motor constants

L=armature inductivity

dl/dt=time derivative of the armature current I.

From this motor equation (3) one can derive both the temperature dependent armature resistance R(T) as well as the temperature dependent magnetic flux Φ(T) through suitable methods by measuring the motor characteristic quantities armature current I, motor voltage U and motor rotational speed n. During the operating process of the window lift drive, several successive measuring processes MV are carried out. In several successive measuring times t_{M} of a measuring process MV, the motor characteristic quantities armature current I, motor voltage U and motor rotational speed n are measured or derived from the measured motor values, and from this N motor equations according to equation (3) are derived. The equation system with N equations resulting for a measuring process MV is solved through a suitable method; as a solution, one obtains the sought-after values armature resistance R and magnetic flux Φ (which is weighted with a motor constant c)—for example, one obtains a solution vector [R, cΦ] by means of Gauss transformation.

For solving the equation system, at least two measuring times t_{M} are necessary per measuring process MV (N≧2), but for increasing the accuracy the number of measuring times t_{M} during the measuring process and therewith the number N of the equations should be selected considerably larger (N>>2; for example N=30). Moreover, the measuring processes MV or the measuring times t_{M} of a measuring process MV should not (exclusively) be selected during the stationary operation, because the measured values for the motor characteristic quantities then (approximately) correspond with one another, and a solution of the equation system thus would not provide any meaningful results.

Since the thermal coupling between armature and permanent magnet of the electrical motor is very poor, the magnetic flux Φ changes much more slowly than the armature resistance R during an operating process of the window lift drive. Therefore, the magnetic flux Φ determined during a measuring process MV at the beginning of an operating process of the window lift drive can be considered as approximately constant for later measuring processes of this operating process, that is to say during the further operating process. Thus, from the equation (3) for the temperature dependent armature resistance R(T), with Φ≈constant (Φ≠Φ(T)), there arises the simplified relationship:

R(T)=[U−cΦ·n−(dI/dt)·L]/I (4)

In the FIGURE, the time progression or course of the motor characteristic quantities motor voltage U and motor current I as well as the time progression or course of the temperature T during an operating process are illustrated; for example the motor voltage U fluctuates between 0 and 15 V during the operating process, the motor current I fluctuates between 0 and 30 A, and the temperature fluctuates between 20° C. and 50° C.

As an example, during the operating process three measuring processes MV are carried out, whereby each measuring process MV comprises a differing number of measuring times t_{M} depending on the conditioning of the coefficient matrix of the arising equation system; for example 10 to 50 measuring times t_{M} are selected per measuring process MV, typically 30 measuring times t_{M} per measuring process MV. During the measuring time t_{M} of a measuring process MV, the present existing values of the motor characteristic quantities armature current I and motor voltage U are measured and the values of the motor rotational speed n are derived from these two measured motor characteristic quantities I, U. Particularly, a measuring process MV is carried out at the beginning (in the run-up phase) of the movement of the electrical motor, for example 30 measuring times t_{M} are selected for this measuring process MV in the run-up phase of the electrical motor; thereby the first measuring time t_{M} is selected exactly at the beginning of the movement of the electrical motor, that is to say exactly at the time point at which the electrical motor begins to turn.

The absolute value of the temperature T determined using the motor characteristic quantities determined during the measuring times t_{M} of a measuring process MV according to equation (3) or equation (4) in combination with equation (1) or equation (2) is compared with a prescribed limit temperature T_{G} (maximum temperature); for example, a limit temperature T_{G} of T=150° C. is prescribed for the “inside temperature” of the electrical motor derived from the magnetic flux Φ according to equation (2), and a limit temperature of T=200° C. is prescribed for the “outside temperature” of the electrical motor derived from the armature resistance R according to equation (1). Upon exceeding the limit temperature T_{G,} suitable measures are taken: for example the window lift drive is switched off or the renewed operation of the window lift drive is prevented temporarily.

1. Method for the protection of an electrical motor against thermal overload, characterized in that
a motor equation that combines at least one temperature dependent motor parameter (R, Φ) and at least one motor characteristic quantity (I, U, n) is defined in connection with a motor model for the electrical motor,
at least one measuring process (MV) is carried out during the operating process of the electrical motor, in which the present existing values of the at least one motor characteristic quantity (I, U, n) are determined in at least two successive measuring times (t_{M}),
the value of the at least one temperature dependent motor parameter (R, Φ) is determined from the motor equations for the measuring times (t_{M}) of a measuring process (MV),
the absolute value of the temperature (T) of the electrical motor is determined in connection with the functional relationship between the at least one temperature dependent motor parameter (R, Φ), and the temperature (T), and
the current flow through the electrical motor is influenced in a defined manner when the determined absolute value of the temperature (T) of the electrical motor reaches a prescribed limit temperature (T_{G}).

2. Method according to claim 1, characterized in that the functional relationship between the at least one temperature dependent motor parameter (R, Φ) and the temperature (T) is defined while using a reference value (R_{REF}, Φ_{REF}) for the at least one temperature dependent motor parameter (R, Φ), and that the reference value (R_{REF}, Φ_{REF}) for the at least one temperature dependent motor parameter (R, Φ) is determined through a reference measurement at a reference temperature (R_{REF}).

3. Method according to claim 1, characterized in that the functional relationship between the at least one temperature dependent motor parameter (R, Φ) and the temperature (T) is defined while using a reference value (R_{REF}, Φ_{REF}) for the at least one temperature dependent motor parameter (R, Φ), and that the reference value (R_{REF}, Φ_{REF}) for the at least one temperature dependent motor parameter (R, Φ) is prescribed as a standard value at a reference temperature (R_{REF}).

4. Method according to one of the claims 1 to 3, characterized in that the values of at least one motor characteristic quantity (U, I, n) determined during a measuring process (MV) and/or an operating process of the electrical motor are taken into account in subsequent measuring processes (MV) and/or operating processes of the electrical motor.

5. Method according to one of the claims 1 to 4, characterized in that the presently existing values of the at least one motor characteristic quantity (U, I, n) are determined during a measuring process (MV) in a plurality of successive measuring times (t_{M}).

6. Method according to one of the claims 1 to 5, characterized in that the absolute value of the temperature (T) of the electrical motor is determined by matrix transformations in connection with the motor equations derived in the measuring times (t_{M}) of a measuring process (MV).

7. Method according to one of the claims 1 to 5, characterized in that the absolute value of the temperature (T) of the electrical motor is determined through an adaptive algorithm in connection with the motor equations derived in the measuring times (t_{M}) of a measuring process (MV).

8. Method according to one of the claims 1 to 7, characterized in that the different temperature dependent motor parameters (R, Φ) have different limit temperatures (T_{G}) allocated thereto.

9. Method according to one of the claims 1 to 8, characterized in that the electrical resistance (R) of the armature winding of the electrical motor and/or the magnetic flux (Φ) necessary for the excitation of the electrical motor are utilized as temperature dependent motor parameters (R, Φ).

10. Method according to one of the claims 1 to 9, characterized in that the motor current (I) and/or the motor voltage (U) and/or the motor rotational speed (n) are utilized as motor characteristic quantities.

11. Method according to claim 10, characterized in that the motor current (I) and the motor voltage (U) are measured in the measuring times (t_{M}) of a measuring process (MV), and that the motor rotational speed (n) is derived from the motor current (I) and the motor voltage (U).

12. Method according to claim 10, characterized in that the motor rotational speed (n) and the motor voltage (U) are measured in the measuring times (t_{M}) of a measuring process (MV), and that the motor current (I) is derived from the motor rotational speed (n) and the motor voltage (U).

13. Method according to one of the claims 1 to 12, characterized in that the current flow through the electrical motor is switched of, when the determined absolute value of the temperature (T) of the electrical motor reaches the limit temperature (T_{G}).

14. Method according to one of the claims 1 to 13, characterized in that the current flow through the electrical motor is blocked for a prescribed time interval, when the determined absolute value of the temperature (T) of the electrical motor reaches the limit temperature (T_{G}).
